(19) United States
(12) Patent Application Publication
(10) Pub. No.: US 2007/0041042 A1
(43) Pub. Date: Feb. 22, 2007

(54) Image processing method and apparatus

(75) Inventors: Yoshiyuki Tamai, Itami-shi (JP); Masami Yamada, Sennan-gun (JP); Hisashi Uchida, Kuze-gun (JP); Hiroyuki Kawabata, Kawanishi-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/360,700

(22) Filed: Feb. 24, 2006

(30) Foreign Application Priority Data
Aug. 22, 2005 (JP) 2005-239772

(51) Int. Cl. G06F 3/12

(52) U.S. Cl. 358/1.15; 358/1.13

(57) ABSTRACT

In a system, first and second image processing apparatuses are connected to each other via a network, and each of the first and second image processing apparatuses having a storage device for storing a job or jobs, each of which includes image data and attribute information including its output format. A first job in the jobs stored in a storage device in the first image processing apparatus is duplicated as a second job stored in a storage device in the second image processing apparatus. The attribute information of the first job is changed, and the attribute information of the second job is changed to the same as that of the first job. Thus, the attribute information is shared in the system.

This application is based on application No. 2005-239772 filed in Japan, the contents of which are hereby incorporated by reference.

### BACKGROUND OF THE INVENTION

The invention relates to a network system for sharing a storage device for storing jobs.

In an image processing apparatus such as a printer or a multi-functional peripheral (MFP), it is known to provide storage regions, called boxes, for storing jobs in a storage apparatus having a large storage capacity. A job includes image data and its output mode. When a job is stored in a box, it can be used again later. Such an image processing apparatus is usually a network device. Personal computers and various types of peripherals including image processing apparatuses can be connected to each other through a network such as a local area network. In such a system, an external device can store a job in a box in an image processing apparatus, and a user can operate it in the box.

When a job stored in a box provided in an image processing apparatus is operated by another device connected to the image processing apparatus, for example, another image processing apparatus, the device may create a copy of the job and store the duplicated job in a box provided in the device when it decides that the job will be used frequently. When a further device needs a copy of the job in a different data format, it can create and store the copy in a box therein. In such cases, the access speed and reusability of the job are improved.

The invention to be explained below is relevant to the relationship between a job stored in a box in an image processing apparatus and its copy stored in another device. The processing on the relationship is described in, for example, Japanese Patent laid open Publications Nos. H9-240108, 2000-330858 and 2001-245163.

In the above-mentioned systems, jobs are stored and used in boxes provided in an image processing apparatus. Further, an external device connected via a network to the image processing apparatus can register and operate a job in a box in the image processing apparatus. A copy of the job may be created and stored in the external device. In such a system, when an attribute of an original job is changed, it is not reflected in its copy if any. Therefore, the copy is used independently of the intention of an operator who registers the job. Especially, when security level of an original job is changed, it is not reflected in the security level of its copy, and this is a problem on security. Therefore, when an attribute (especially security level) is changed, it is desirable to be reflected in its copy.

In an image processing apparatus such as a computer disclosed in Japanese Patent laid open Publication 2000-330858, an image data and its image attribute data are dealt with as an object. Objects are linked to each other to have a hierarchical system including a parent-and-child relationship. It is to be noted that this parent-and-child relationship is not that of class, but that of instance. When an image attribute data of an object is changed, it is reflected in its child object. However, a child object and the like in an external apparatus connected via a network are not explained.

As to an image processing apparatus connected to a network, a printer described in Japanese Patent laid open Publication H9-240108 receives an instruction to transfer a secret document data from an host connected via a network, and the secret document is stored automatically in a box in correspondence with its password. The secret document is managed with a box number and its password. The password is generated by the printer and is transferred to the host to notify it to an operator. In the printer, the security level of the box is changed according as the job to be stored in a box is a secret document or not. However, a change in security level is not mentioned for a copy of a secret document stored in an external device connected via a network. In a facsimile apparatus disclosed in Japanese Patent laid open Publication 2001-245163, when a facsimile image data of a secret document is stored in a box, and it is taken out by an external terminal connected via a network, it is dealt differently from an ordinarily received document to keep secrecy. Before it is transferred, it is converted to a predetermined format for a secret document. For example, it is transferred by adding a password according to a format in correspondence to the destination. However, a change in security level after the transmission is not explained.

### SUMMARY OF THE INVENTION

An object of the invention is to reflect a change in attribute information of a job stored in a box in an image processing apparatus for a copy of the job in a system including the image processing apparatus.

In an aspect of the invention, an image processing method is provided for sharing attribute information in a system wherein first and second image processing apparatuses are connected to each other via a network/ Each of the first and second image processing apparatuses has a storage device for storing a job or jobs, each of the job or jobs having image data and attribute information including its output format. A first job in the jobs stored in a storage device in the first image processing apparatus is duplicated as a second job stored in a storage device in the second image processing apparatus. If the attribute information of the first job is changed, the attribute information of the second job is changed to the same as that of the first job.

In another aspect of the invention, an image processing apparatus has a storage device for storing a first job having image data and attribute information including its output format. It is connected via a network to another image processing apparatuses having a storage device for storing a second job as a duplication of the first job. In the former image processing apparatus, an operation device receives an instruction for changing the attribute information of the first job, and an attribute changer changes attribute information of the second job to the same as that of the first job when the operation device receives the instruction for changing the attribute information of the first job.

In a further aspect of the invention, an image processing apparatus has a storage device for storing a second job as a copy of a first job, and it is connected via a network with another image processing apparatus having a storage device for storing the first job having image data and attributes including its output format. In the image processing apparatus, an operation device receives an instruction for operating a change in the attribute information of the first or second job. A decider device decides whether the attribute information of the first job has been changed or not when the instruction is received by the operation device, and an attribute changer changes the attribute information of the second job to the same as that of the first job when the attribute information of the first job has been changed.

An advantage of the present invention is that when attribute information of an original job in a box in an image processing apparatus is changed, if a copy of the job is present, the attribute information of the copy can reflect the change in the attribute information of the original job.

Another advantage of the present invention is that when a security level of an original job is changed, it can be reflected to a copy of the job.

### BRIEF DESCRIPTION OF THE DRAWINGS

These and other objects and features of the present invention will become clear from the following description taken in conjunction with the preferred embodiments thereof with reference to the accompanying drawings, and in which:

FIG. 1 is a diagram of a network including multi-functional peripherals;

FIG. 2 is a block diagram of a structure of a multi-functional peripheral;

FIG. 3 is a flowchart of a processing for printing a job stored in a box in a first multi-functional peripheral at a second one;

FIG. 4 is a flowchart of a processing for changing an attribute of a job by an operator;

FIG. 5 is a flowchart of a processing for instructing to change an attribute for a job in a second multi-functional peripheral in a second embodiment;

FIG. 6 is a flowchart of a processing for instructing to print a job in the second multi-functional peripheral;

FIG. 7 is a flowchart of a processing for reading and storing an image in a first multi-functional peripheral in a third embodiment;

FIG. 8 is a flowchart of a processing for distributing a job stored in the first multi-functional peripheral in jpeg format;

FIG. 9 is a flowchart of a processing for setting a password and encryption for a job when its copy is stored in a second multi-functional peripheral;

FIG. 10 is a flowchart of a processing for sending a job in the second multi-functional peripheral in jpeg format;

FIG. 11 is a flowchart of a processing for setting a password and encryption for a job in a first multi-functional peripheral in a fourth embodiment; and

FIG. 12 is a flowchart of a processing for instructing for sending a job in a second multi-functional peripheral.

### DETAILED DESCRIPTION OF THE PREFERRED EMBODIMENTS

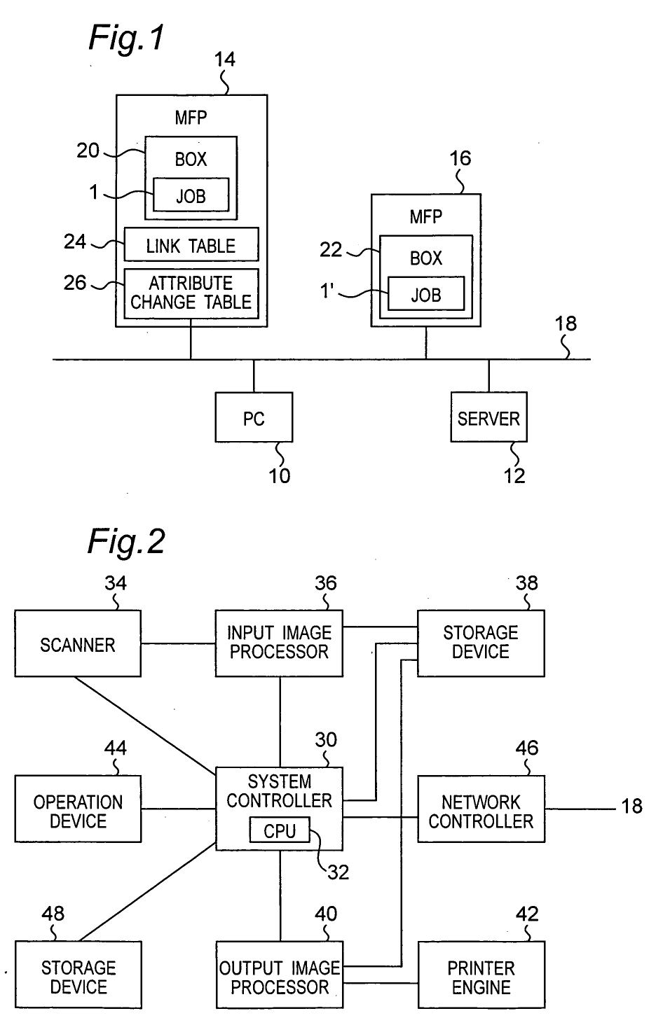

Referring now to the drawings, wherein like reference characters designate like or corresponding parts throughout the several views, FIG. 1 shows a network, wherein a computer (PC) 10, a server apparatus 12 and multi-functional peripherals (MFPs) 14, 16 as examples of image processing apparatuses, are connected to a network 18 such as a local area network. The MFPs 14, 16 can be operated as a printer, a scanner, a copying machine and the like, and the MFP 14 or 16 is shared by the computer 10, the server apparatus 12 and the other MFP 16 or 14. Each of the MFPs 14, 16 has a built-in hard disk drive or the like as a storage device with a large storage capacity enough to store many documents. In such a storage device, regions to be used exclusively are called boxes. Boxes 20 or 22 can be shared by the personal computer 10, the server apparatus 12, the MFP 16 or 14 and the like connected via the network 18. Therefore, an operator of the personal computer 10, the server apparatus 12, the MFP 16 or 14 can operate a job in a box in the MFP 14, 16 for printing, transmission or the like. Further, a job including image data and its output format sent from an external device to the MFP 14, 16 can also be stored in a box 20, 22.

FIG. 2 shows a structure of the MFP 14, 16 having a system controller 30 including a central processing unit 32 for controlling the entire system. The system controller 30 is connected to a scanner 34 for reading an image, an image data processor 36 for processing input image data read by the scanner 34, a storage device 38 for storing image data, an output image processor 40 for processing image data to output print data, a printer engine 42 for printing the print data on a sheet of paper, an operation device 44 provided for inputting various instructions and for displaying various screens, a network controller 46 for communication with the external network 18, and a storage device 48 with a large storage capacity such as a hard disk drive. The facsimile function of the MFP is not explained here. When the MFP is operated as a printer, an image is printed by the printer engine 42. When it is operated as a copying machine, an image read by the scanner 34 is printed with the printer engine 42. The operation device 44 receives various instructions and data and displays various screens. The storage device 48 is divided into a plurality of storage regions or boxes, and each box can store many jobs. An operator can set an instruction for an operation such as print or a processing for jobs registered in a box with the operation device 44.

A job stored in a box 20 in the MFP 14 can be operated from an external device such as the personal computer 10 or another MFP 16 connected via the network 18 to the MFP 14. When an operator of the other MFP 16 operates a job (first job) 1 stored in a box 20 in the MFP 14, as shown in FIG. 1, a copy 1′ of the job (second job) or a duplicated job is created, and it may be stored in a box 22 in the MFP 16 outside the MFP 14. The duplicated job 1′ may be created automatically when the MFP 16 decides that it will be used frequently. Further, when a job in a different format is needed, a duplicated job may be created in the different format. Alternatively, an operator of the second MFP 16 may create a duplicated job when he or she wants it. When a duplicated job is stored in the other MFP, the access speed and reusability of the job are improved. When the duplicated job 1′ is created, link management information or information on the relationship between the original job 1 and the duplicated job 1′ is registered in a link table 24. Then, when the job 1 in the MFP 14 is operated, it is found with reference to the link table 24 whether a duplicated job 1′ is present or not. When the duplicated job 1′ is present, the duplicated job 1′ is operated instead of the original job 1. Though the link table 24 is provided in this example in the MFP 14 which stores the original job 1, it may be provided in the server apparatus 12, the other MFP 16 or the like. After the duplicated job 1′ is created, one of the attributes of the original job 1 may be changed. In such a case, when the job 1 in the MFP 14 is instructed to be operated, the duplicated job 1′ is operated actually. Therefore, the duplicated job 1′ with the changed attribute information has to be operated. Thus, the counterpart attribute information of the duplicated job 1′ should be changed to accord with the attribute information of the original job 1 at an appropriate timing in correspondence the change in the attribute information of the original job 1 linked to the duplicated job 1′.

The attribute information of a job includes an output format of the image data of the job. For example, it include file name, creator's name, color/monochromatic, password, resolution, number of copies, paper-feeding cassette, paper size, paper type, destination of transmission, whether to acknowledge transmittal or not, and how to confirm acknowledgement. Thus, the attribute information includes security level such as a password besides the attributes of the image data itself such as file name and those of output format thereof such as resolution. Therefore, when the security level of the original job linked to the duplicated job in the link table is changed, the attribute information of the duplicated job should be kept to be the same as that of the original job or to accord with the counterpart of the original job, so that the operation of the duplicated job can reflect the change in security level. Further, the attribute information is not limited to the above-mentioned example. For example, the attribute information may include data format because the change in data format is necessary in a network including various data formats.

In the first embodiment, a duplicated job 1′ as a copy of a job 1 stored in a box 20 in an image processing apparatus such as MFP 14 is created in a box in an external image processing apparatus such as a box 22 in MFP 16. When an operator changes an attribute of the job 1 in the box 20 in the first MFP 14, the counterpart of the duplicated job 1′ stored in the second MFP 16 is changed automatically to the same as the attribute of the job 1. Thus, when an attribute of the job 1 is changed, it is reflected readily to the counterpart of the duplicated job 1′.

Next, among the processing to be executed by the system controller 30, a processing related to the change in attribute information is explained.

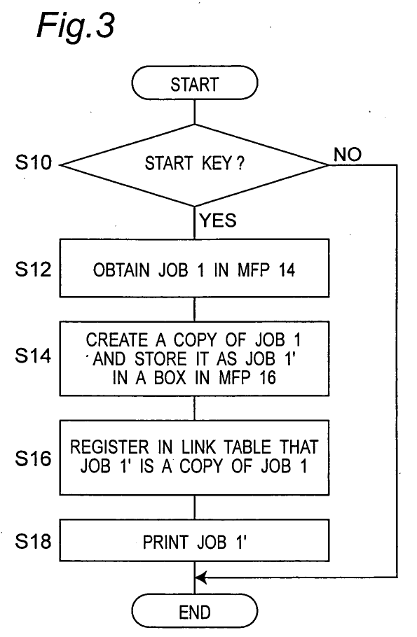

First, a processing including creation of a duplicated job is explained. FIG. 3 shows a flowchart of printing a job 1 stored in the box 20 in the MFP 14 to be executed by the system controller 32 of the MFP 16. When an operator “A” of the second MFP 16 selects a job 1 in the box 20 in the MFP 14 and sets print conditions and presses a start key in the operation device 44 for printing the job 1 (YES at S10) or when printing of the job 1 in the first MFP 14 is instructed, the job 1 in the MFP 14 is obtained (S12). If the job satisfies predetermined conditions such as frequency, a copy of the job 1 is created and is stored as a duplicated job 1′ automatically in the box 22 in the second MFP 16 (S14). Alternatively, the operator may create a copy of the job 1 and store it as a duplicated job 1′. When the duplicated job 1′ is created, relationship information (or link management information) between the original job 1 and the duplicated job 1′ is registered in the link table 24 (S16). Next, printing of the duplicated job 1′ is executed (S18), to provide a print of the job 1.

Next, a processing for changing an attribute of a job in the first MFP 14 is explained. When an operator changes an attribute of the original job 1 in the MFP 14, it is reflected readily to the counterpart of the duplicated job 1′ in the MFP 16 with reference to the link management information in the link table 24.

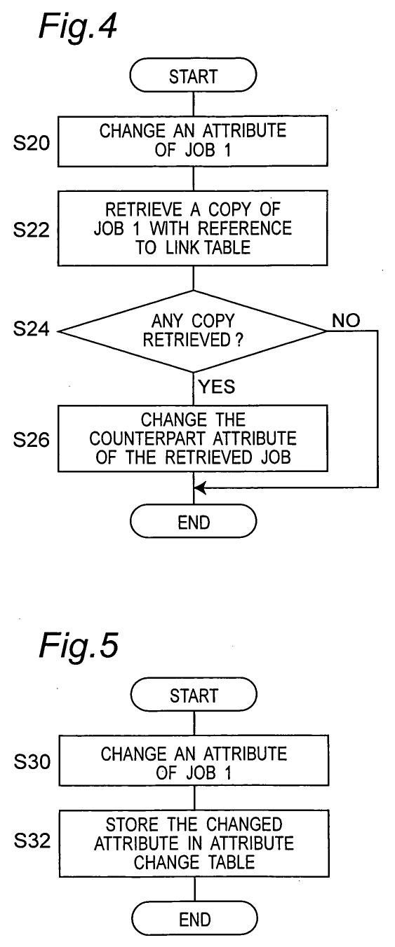

FIG. 4 shows a flowchart for changing an attribute of a job 1, to be executed by the system controller 32 of the MFP 14. When an operator “B” of the MFP 14 instructs to change an attribute of a job 1, the attribute of the job 1 is changed (S20). For example, a password is set. Thus, the security level is changed. Next, a duplicated job related to the job 1 is retrieved in the link table 24 (S22). In this example, a duplicated job 1′ is found in MFP 16. When the duplicated job 1′ is found (YES at S24), the counterpart attribute information of the duplicated job 1′ is changed to the same as or to accord with the attribute information of the original job 1 (S26). Thus, when an attribute of the job 1 is changed, the counterpart of the duplicated job 1′ is kept the same as the attribute of the original job 1.

Next, a second embodiment of the invention is explained. In this embodiment, when an attribute of an original job 1 in the first MFP 14 is changed, the counterpart in a copy 1′ of the job in the second MFP 16 is not changed simultaneously, and a fact that the attribute is changed is registered in an attribute change table 26. When the duplicated job 1′ is operated in the second MFP 16 at a later time, the attribute information of the duplicated job 1′ is changed to the same as the counterpart of the original job 1. Therefore, the timing is different from the first embodiment on the change in the attribute information of the duplicated job to the counterpart in the original job.

In the second embodiment, when an operator “A” of the MFP 16 selects a job 1 in the MFP 14 and presses the start key, a duplicated job 1′ as a copy of the job 1 is created and stored in the box in the MFP 16. The processing of the creation of the duplicated job 1′ is similar to the first embodiment shown in FIG. 3. At this time, relationship information (or link management information) between the original job 1 and the duplicated job 1′ is registered in the link table 24.

Next, a processing is explained for changing an attribute of a job in the first MFP 14. When an operator “B” changes an attribute of the job 1, the counterpart of the duplicated job 1′ is not dealt with at the timing. Instead, information on the change in the attribute information of the job (job change information) is registered in the attribute change table 26. This table 26 is provided, for example, in the MFP 14 which stores the original job 1. Alternatively, it is provided in the external server 12 or in the MFP 16 wherein the duplicated job 1′ is created.

FIG. 5 shows a flowchart of changing an attribute of the job 1, to be executed by the system controller 32 of the MFP 14. When an operator “B” of the MFP 14 instructs to change an attribute of a job with the operation device 44, the attribute of the job 1 in the MFP 14 is changed (S30). For example, a password of the job is set, and the security level is changed. Then, a fact that the attribute of the job 1 is changed by the operator “B” is stored in the attribute change table 26 (S32). In contrast to the first embodiment, the counterpart attribute of the duplicated job 1′ in the MFP 16 is not changed at this time.

Next, when the original job 1 is operated at the second MFP 16, the attribute information of the duplicated job related to the job 1 is changed to accord with the counterpart of the original job 1. A processing wherein the operation of the job is printing is explained here.

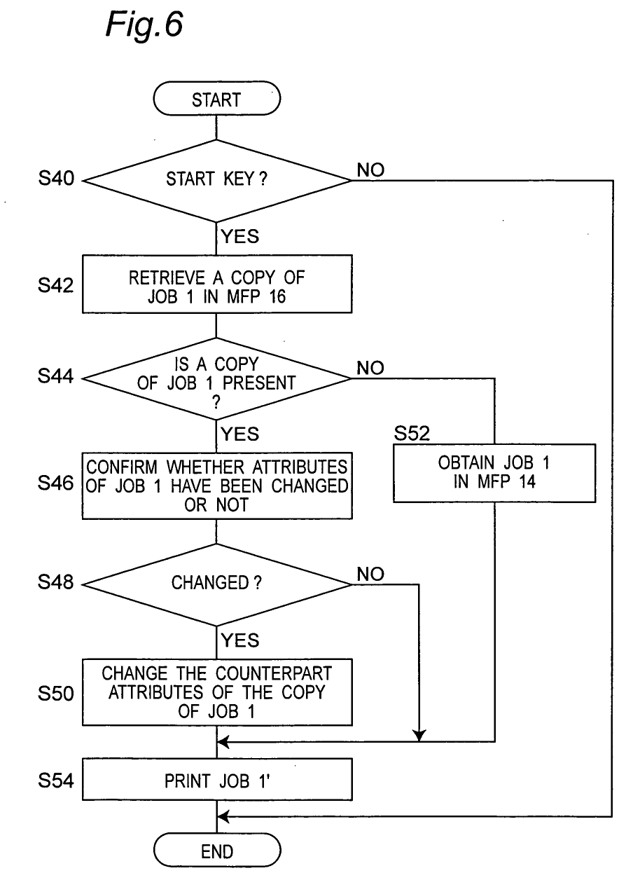

FIG. 6 shows a flowchart to be executed by the system controller 32 of the MFP 16 when it is instructed to print the job 1. When printing of the job in the MFP 14 is instructed, or when an operator “C” selects the job 1 in the MFP 14 and sets print conditions and presses start key with the operation device 44 (YES at S40), a duplicated job linked to the original job 1 is retrieved in the link table 24 (S42). In this example, the duplicated job 1′ is found. When the duplicated job 1′ is found (YES at S44), it is confirmed with the attribute change table 26 whether the attribute information of the original job 1 has been changed or not (S46). When the attribute information of the job 1 has been changed (YES at S48), the attribute information of the duplicated job 1′ is changed to the same as the counterpart of the job 1 (S50). Then, the printing of the duplicated job 1′ is executed (S54) to provide a print of the duplicated job 1′ at the MFP 16. On the other hand, when no job in the FMP 16 related to the original job 1 is found in the link table 24 (NO at S44), the job 1 in the MFP 14 is obtained (S52), and the printing of the job 1 is executed (S54) to provide a print of the job 1 at the MFP 16.

As mentioned above, in the second embodiment, when the job 1 is operated at the MFP 16, the attribute information of the duplicated job 1′ is changed to accord with the counterpart of the original job 1. Alternatively, when the duplicated job 1′ is operated at the MFP 16, the attribute information of the duplicated job 1′ is changed to accord with the counterpart in the original job 1.

In the above-mentioned first and second embodiments, the attribute change of the job in an MFP can be reflected to the attribute information in the duplicated job 1′ stored in a different MFP. However, there are cases wherein the attribute change of the original job cannot be reflected to the attribute information in the duplicated job 1′. Further, there are cases wherein a part of the attribute information is lost when a file format of the file is changed. In order to deal with such cases, an application for processing such cases is provided in the MFP so that an operator need not become conscious of a difference in the procedure for changing the attribute information. For example, even when a part of attribute information is lost from the image data due to the change in data format of the image data, the application makes it possible as a job mode to add and change the attribute to restore the original attribute information.

In a third embodiment, a change in an attribute of a job is instructed, but it cannot be set for an image file of the job. In an example, a file format of the image file is different between an original file (job) and a copy of the file. The method for changing security level is different among file formats, and the change in security level cannot be dealt as a change in an attribute in some file formats. However, it is desirable that a user needs not become conscious of the difference in data format when operating a job. Then, an application is provided in the MFP to be used when attribute information including a password and encryption are changed. Thus, the operation procedure for changing an attribute is similar for the operator, irrespective of data format.

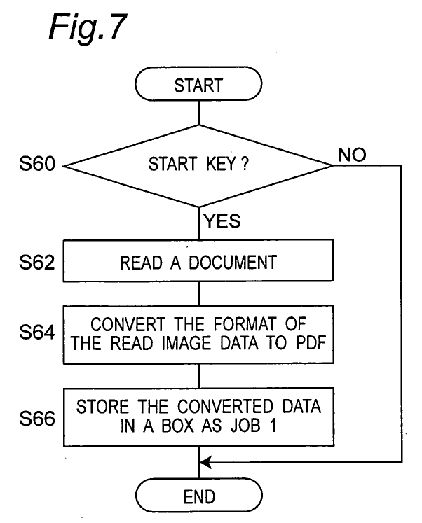

FIG. 7 is a flowchart of reading an image and storing it in the box 20, to be executed by the system controller 32 of the MFP 14. When scan is designated and start key in the operation device 44 is pressed by an operator (YES at S60), a document is read by the scanner 34 (S62). Next, the image format of the image data read by the scanner 34 is converted to a designated data format (portable document format (pdf format) in this example) (S64), and it is stored as a job 1 in the box 20.

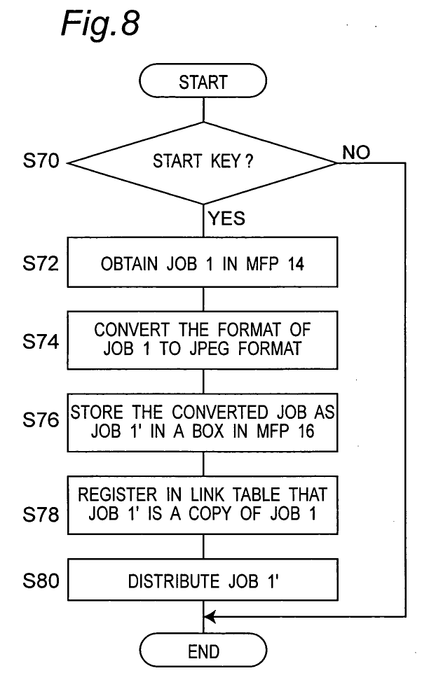

FIG. 8 is a flowchart of distributing the job 1′ in the MFP 16 in jpeg format, to be executed by the system controller 32 of the MFP 16. When an operator of the MFP 16 selects the job 1 in the MFP 14, instructs distribute thereof in jpeg format and presses start key (YES at S70), the job 1 is obtained from the MFP 14 (S72), and the data format of the image data of the job 1 is converted to jpeg format (S74). Thus, a duplicated job 1′ in jpeg format is created as a copy of the job 1 in the MFP 16. Then, the created job 1′ is stored in a box in the MFP 16 (S76), and relationship information between the original job 1 and the duplicated job 1′, or information that the job 1′ is created from the original job 1, is registered in the link table 24 (S78). Then the duplicated job 1′ is distributed (S80).

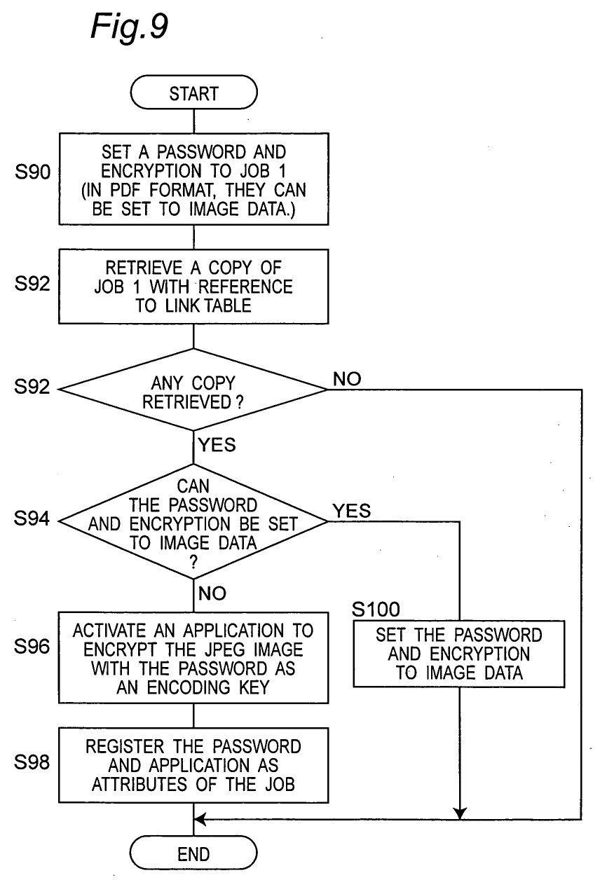

FIG. 9 is a flowchart of setting a password and encryption to the original job 1, to be executed by the system controller 32 of the MFP 16, when a duplicated job 1′ is stored in a box in the MFP 16. In this example, “encryption” denotes encryption of job data, and “password” denotes a password requested when the job file is decrypted. When an operator “C” of the MFP 16 instructs a password and encryption for the job 1, the password and encryption are set for the image data of the job 1 (S90). The file format of the job 1 is pdf format. In pdf format, the format itself has a function for encryption. Then, a password for opening a file can be designated, and the image data of the job is stored in combination with the password. Next, a duplicated job related to the job 1 is retrieved if any with reference to the link table 24 (S92). In this example, the duplicated job 1′ is found (YES at S92). Then, it is decided whether the password and encryption can be set to the image data of the duplicated job 1′ (S94). In this example, the file format of the duplicated job 1′ is jpeg format, and the password and encryption cannot be set to the job. If not possible (NO at S94), an encryption application in the MFP 16 is activated to add the password information related to the duplicated job 1′ as an encryption key to encode the image in jpeg format (S96). Then, the password and encryption information including the type of encryption are registered as attributes of the job (S98). On the other hand, when the password and the encryption information can be set to the image data in the job (YES at S94), the password is set to the image data, and the image data is encrypted (S100). In this example, the operator C changes the setting of password and encryption information at the MFP 16. Alternatively, the setting can be changed at the MFP 14.

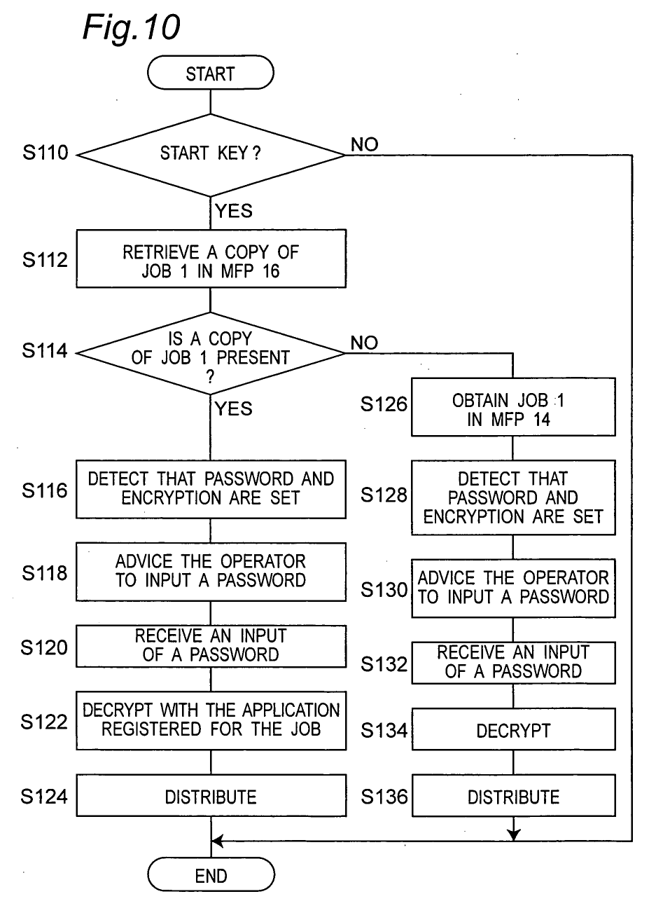

FIG. 10 is a flowchart of distributing the job 1 in jpeg format, to be executed by the system controller 32 of the MFP 16. When an operator “C” of the MFP 16 selects the job 1, instructs distribution of the job in jpeg format and presses start button (YES at S110), it is retrieved with reference to the link table 24 whether a duplicated job is present in the MFP 16 or not (S112). When the duplicated job 1′ is present (YES at S114), it is detected that the password and encryption information is set to the duplicated job 1′ (S116), and a screen for inputting a password is displayed in the operation device 44 (S118), to advise the operator to input a password. When a password inputted by the operator is received (S120), the data is decrypted with the encryption application registered fo the original job with the received password (S122). Then, the decrypted job including the image data in jpeg format is distributed (S124). On the other hand, when no duplicated job 1′ is present (NO at step S114), the job 1 is obtained from the MFP 14 (S126), and it is confirmed that the password and encryption information are set (S128). Then, a screen for receiving a password is displayed in the operation device 44 (S130), to advise the operator to input a password. When the password is received (S132), the decryption is performed with the password (S134). Then, the data format of the decrypted image data is converted to jpeg format and distributed (S116).

In a fourth embodiment, when attributes including password and encryption of a job are changed in the first MFP, the attribute information of the duplicated job in a different format in the second MFP is not changed quickly, and the change in the attribute information is registered in the attribute change table. When the duplicated job is operated later in the second MFP, the attribute information of the duplicated job is changed to the same as the counterpart of the original job. Therefore, the timing to change the attribute information of the duplicated job in this embodiment is different from the third embodiment.

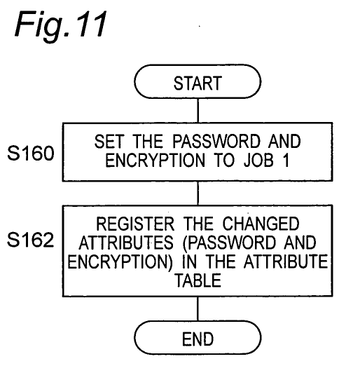

FIG. 11 shows a flowchart of setting a password and encryption information to the original job 1, to be executed by the system controller 32 of the MFP 14. According to an instruction of the password and encryption information at the operation device 44, the password and encryption information are set to the job 1 in the MFP 14 (S160). Thus, the security level of the job 1 is changed. Next, it is registered in the attribute change table 26 that the attribute information of the original job is changed by an operator (S162). In contrast to the third embodiment, the attribute information of the duplicated job 1′ in the MFP 16 is not changed this time. In this example, the setting of password and encryption information for the job 1 is changed at the MFP 16. Alternatively, it can be changed at the MFP 14.

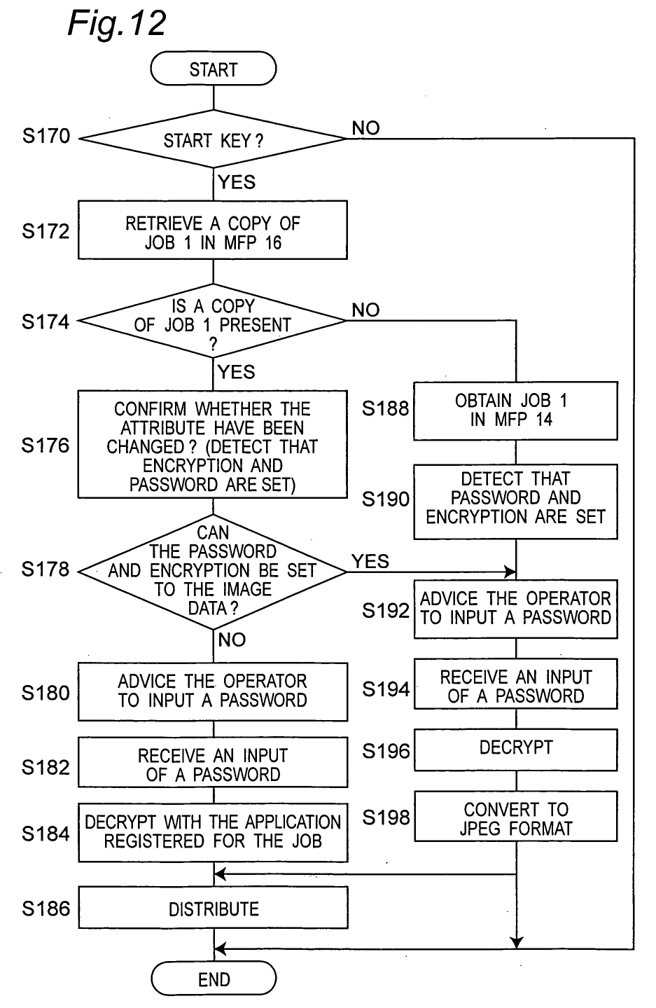

FIG. 12 shows a flowchart to be executed by the system controller 32 of the MFP 16 when distribution of a job 1 is instructed in the MFP 16. When an operator “C” of the MFP 16 selects a job 1 in the MFP 14, instructs distribution of the job 1 in jpeg format and presses start key in the operation device 44 (YES at S170), a duplicated job linked to the original job 1 is retrieved in the link table 24 (S172). In this example, the duplicated job 1′ is found with the link table 24 (YES at S174). Then it is confirmed in the attribute change table 26 whether the attribute information of the duplicated job 1′ has been changed or not (S176). When the attribute information is confirmed to have been changed and the change is found to be instructed by an operator, it is decided whether the attribute information can be set to the duplicated job 1′ or not (S178). In the example, it is confirmed that the operator sets the password and encryption to the image data of the job 1, but the job format does not allow them to be set as attributes. Therefore, a screen for inputting a password is displayed in the operation device 44 (S180), to advise the operator to input the password. When an input of password is received (S182), the encryption application registered for the original job 1 is used for decryption with the input password (S184). Then, the decrypted job including the image data in jpeg format is distributed (S186). On the other hand, when the password and encryption can be set to the image data of the job 1 (NO at step S178), the password and encryption are set to the job, and a screen for receiving a password is displayed in the operation device 44 (S192), to notify the user to input a password. When a password is received (S194), decryption is performed with the password by using the encryption application registered to the job 1 (S196). Then, the image data is converted to jpeg format (S198), and the decrypted image data are distributed (S186).

As mentioned above, in the fourth embodiment, when the original job 1 is operated in the MFP 16, the attribute information of the duplicated job 1 is changed to the same as the counterpart of the job 1. Alternatively, when the duplicated job 1′ is operated in the MFP 16, the attribute information of the duplicated job 1′ is changed to the same as the counterpart of the original job 1.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. An image processing method for sharing attribute information in a system wherein first and second image processing apparatuses are connected to each other via a network, each of the first and second image processing apparatuses having a storage device for storing a job or jobs, each of the job or jobs comprising image data and attribute information including its output format, comprising:
duplicating a first job in the jobs stored in a storage device in the first image processing apparatus as a second job stored in a storage device in the second image processing apparatus;
changing the attribute information of the first job; and
changing the attribute information of the second job to the same as that of the first job.

2. The image processing method according to claim 1, wherein the attribute information of the second job is changed when the attribute information of the first job is changed.

3. The image processing method according to claim 1, further comprising operating the first or second job according to an instruction by a user, wherein the attribute information of the second job is changed when an operation of the first or second job is instructed.

4. The image processing method according to claim 3, further comprising storing information on the change in the attribute information when the attribute information of the first job is changed, wherein the attribute information of the second job is changed with reference to the information on the change in the attribute information of the first job.

5. The image processing method according to claim 3, wherein the operation of the first or second job is transmission or print thereof.

6. The image processing method according to claim 1, further comprising activating an application for restoring lost information in the attribute information of the second job if a part of the attribute information is lost due to the instructed operation for the second job.

7. The image processing method according to claim 6, wherein the lost attribute information is a change in security level.

8. The image processing method according to claim 7, wherein a format of the image data of the first job is different from that of the image data of the second job.

9. An image processing apparatus having a storage device for storing a first job comprising image data and attribute information including its output format, the image processing apparatus being connected via a network to another image processing apparatuses having a storage device for storing a second job as a duplication of the first job, comprising:
an operation device which receives an instruction for changing the attribute information of the first job; and
an attribute changer which changes the attribute information of the second job to the same as that of the first job when the instruction is received by said operation device.

10. An image processing apparatus having a storage device for storing a second job as a duplication of a first job, the image processing apparatus being connected via a network with another image processing apparatus having a storage device for storing the first job comprising image data and attributes including its output format, comprising:
an operation device which receives an instruction for operating a change in the attribute information of the first or second job;
a decider device which decides whether the attribute information of the first job has been changed or not when the instruction is received by said operation device; and
an attribute changer which changes the attribute information of the second job to the same as that of the first job when said decider device decides that the attribute information of the first job has been changed.

11. The image processing apparatus according to claim 10, wherein the operation of the first or second job is transmission or print thereof.

12. The image processing apparatus according to claim 10, further comprising activating an application for restoring lost information in the attribute information of the second job if a part of the attribute information is lost due to the instructed operation for the second job.

13. The image processing apparatus according to claim 12, wherein the lost attribute information is a change in security level.

14. The image processing apparatus according to claim 13, wherein a format of the image data of the first job is different from that of the image data of the second job.

15. An image processing program to be executed by an image processing apparatus having a storage device for storing a first job comprising image data and attribute information including its output format, the image processing apparatus being connected via a network with another image processing apparatuses having a storage device for storing a second job as a duplication of the first job, the program comprising the steps of:
receiving an instruction for changing the attribute information of the first job; and
changing the attribute information of the second job to the same as that of the first job when the instruction is received.

16. An image processing program to be executed by an apparatus having a storage device for storing a second job as a duplication of a first job, the image processing apparatus being connected via a network with another image processing apparatus having a storage device for storing the first job comprising image data and attributes including its output format, the program comprising the steps of:
receiving an instruction for operating a change in the attribute information of the first or second job;
deciding whether the attribute information of the first job has been changed or not when the instruction is received; and
changing the attribute information of the second job to the same as that of the first job when it is decided that the attribute information of the first job has been changed.
